(19) United States
(12) Patent Application Publication
(10) Pub. No.: US 2012/0047076 A1
(43) Pub. Date: Feb. 23, 2012

(54) SYSTEM, METHOD AND COMPUTER PROGRAM FOR NEGOTIATING ONLINE TRANSACTIONS

(75) Inventor: Jamsheed Hasan BURNEY, Hyderabad (IN)

(73) Assignee: TRAVELSURF PRIVATE LIMITED, Hyderabad (IN)

(21) Appl. No.: 13/289,774

(22) Filed: Nov. 4, 2011

Related U.S. Application Data
(63) Continuation of application No. PCT/CA2011/000245, filed on Mar. 10, 2011.
(60) Provisional application No. 61/312,772, filed on Mar. 11, 2010.

(51) Int. Cl. G06Q 20/00

(52) U.S. Cl. 705/80

(57) ABSTRACT

The present invention provides a system, method and computer program for negotiating online transactions. The method includes obtaining a price for an item from one or more sellers. A buyer can make possibly dissimilar offers for one or more of the items. If all offers are less than all the prices for those items, the offer is rejected and a seller can negotiate the price for reoffer to the buyer. If the offer is at least as high as one of the prices, a transaction is processed between the buyer and a seller. If the offer meets the price of more than one seller, the seller to transact with may be determined based on a prioritized list from the buyer.

### PRIORITY

This application is a continuation of PCT Application No. PCT/CA2011/000245, which claims priority from U.S. Provisional Patent Application No. 61/312,772, filed Mar. 11, 2010, which is incorporated herein by reference.

### TECHNICAL FIELD

The present invention relates generally to negotiating online transactions.

### BACKGROUND OF THE INVENTION

Online travel distribution enables distribution of travel products including, for example, airline seats, hotel rooms, car rentals, cruises and packaged tours.

Existing online travel distribution models can broadly be grouped into two categories, the direct model and third party aggregator model.

The direct model enables travel sellers to offer an online booking facility typically directly from their own website. This type of booking method is becoming more popular as new advanced search engines make it easier for buyers to find each seller's website and book directly with the seller.

In the direct model, travel sellers offer buyers the opportunity to book travel products online at the price quoted by the seller. The price and discount structures are set by the travel seller. In all cases the buyer is quoted a purchase price and can either book at the price quoted by seller or not at all.

Third party aggregator models make travel products available to buyers by enabling buyers to search multiple sellers, compare prices of products, and book the product of their choice. Third party aggregators generally pick surplus inventories from travel sellers at highly discounted, wholesale rates on consignment and offer these on their portals at a marked up price to buyers.

A variation to the aggregator model is the reverse auction model, which offers buyers the option to set a price for a certain category of travel product. The buyer provides a binding blind offer for such a product without knowing the actual travel seller or the actual product. These details are communicated to the buyer only after the binding offer is accepted by one of the travel sellers and the transaction is processed.

Travel products are perishable in nature and typically have a low variable cost associated to them. This perishable nature drives pressure on sellers and provides the motivation for sellers to sell-off their unsold, surplus inventories at high discounts.

While third party aggregators initiate increased sales, their use can create numerous issues for seller and buyers. For example, the discounted rates of the seller are exposed to the general public. This reduces the likelihood of the seller selling other inventory in other market segments at higher prices

The use of third party aggregators also results in serious segment crossovers, whereby high paying buyers cancel purchases made directly with the seller and rebook the same inventory at a lower rate from the third party aggregator. The effect of segment crossovers simply results in reshuffling of the seller's inventory rather than increasing sales volume, resulting in reduced revenues for the seller.

Highly discounted rates can also lead to a deterioration of public perception of the seller and the seller's products. Travel sellers also lose some control over product pricing, which can be extremely detrimental for the seller's growth. The business objectives of sellers and third party aggregators are not aligned.

Furthermore, with price being a primary differentiating factor, price wars can occur among sellers. Very low prices can lead to poor service to buyers due to lack of margins. They can also cause sellers to go out of business due to low profitability.

While the reverse auction model addresses some of these issues, it still focuses on price as its primary defining criteria. However, travel products and services are not commodities and do not compete on price alone. For example, a particular four star hotel may have a wholly different value to the buyer than another four star hotel in the same location.

It is an object of the present invention to provide a system in which the above disadvantages are obviated or mitigated.

### SUMMARY

In one aspect, the present invention provides a computer implemented method for processing one or more transactions, the method characterized by: (a) enabling one or more sellers to provide one or more products, each said product being made available for a respective price; (b) defining a predetermined number of transactions; (c) enabling a buyer to submit one or more possibly dissimilar offers for one or more of said products; and (d) processing, by a computer processor, one or more transactions, each said transaction including a purchase of one of said products if said offer is greater than or equal to said price, wherein the number of said transactions processed is less than or equal to said predetermined number of transactions.

In another aspect, the present invention provides a system for processing one or more transactions, the system characterized by: (a) a seller inventory database, said seller inventory database enabling one or more sellers to provide one or more products, each said product being made available for a price; (b) a buyer computer, said buyer computer enabling a buyer to submit one or more possibly dissimilar offers for one or more of said products; and (c) a network accessible server in network communication with said seller inventory database and said buyer computer, said server operable to process one or more transactions, wherein each said transaction includes a purchase of one of said products if said offer is greater than or equal to said price, wherein the number of said transactions processed is less than or equal to said predetermined number of transactions.

In a further aspect, the present invention provides a computer implemented method for negotiating a transaction, the method characterized by: (a) enabling one or more sellers to provide one or more products, each said product being made available for a price; (b) enabling a buyer to submit one or more possibly dissimilar offers for one or more of said products; (c) generating, by a computer processor, a rejection signal if each said offer is less than a respective one of said price, said rejection signal enabling at least one of said one or more sellers to revise said price of a respective one of said products for providing a counter offer to said buyer; and (d) generating, by a computer processor, an acceptance signal if at least one offer is greater than or equal to a respective one of said price, said acceptance signal enabling processing, by a computer processor, of said transaction, said transaction including a purchase of at least one of said products for which a respective one of said offer is greater than or equal to a respective one of said price.

In a yet further aspect, the present invention provides a system for negotiating a transaction, the system characterized by: (a) a seller inventory database, said seller inventory database enabling one or more sellers to provide one or more products, each said product being made available for a price; (b) a buyer computer, said buyer computer enabling a buyer to submit one or more possibly dissimilar offers for one or more of said products; and (c) a network accessible server in network communication with said seller inventory database and said buyer computer, said server operable to generate a rejection signal if each said offer is less than a respective one of said price, said rejection signal enabling at least one of said one or more sellers to revise said price for providing a counter offer to said buyer, and generate an acceptance signal if at least one offer is greater than or equal to a respective one of said price, said acceptance signal enabling processing, by a computer processor, of said transaction, said transaction including a purchase of at least one of said products for which a respective one of said offer is greater than or equal to a respective one of said price.

### DESCRIPTION OF THE DRAWINGS

Embodiments will now be described by way of example only with reference to the appended drawings wherein:

FIG. 1 is a block diagram illustrating a network linked computer system;

FIG. 2 is a flow diagram illustrating a buyer placing one or more offers;

FIG. 3 is a flow diagram illustrating processing of an offer;

FIG. 4 is a flow diagram illustrating a counter offer by a seller and an increased offer by a buyer;

FIG. 5 is a flow diagram illustrating a counter offer by a buyer; and

FIG. 6 is a flow diagram illustrating another embodiment of a method of negotiating an online transaction.

### DETAILED DESCRIPTION

The present invention provides a system, method and computer program for negotiating and processing online transactions between a buyer and one or more sellers. In one aspect, the present invention enables a buyer to enter into a predetermined number of transactions with one or more sellers by negotiating with at least the one or more sellers.

Sellers may, for example, sell any type of surplus perishable product or service. Sellers may also sell non-perishable products or services. For simplicity, the term “product” shall hereinafter be used to refer to perishable and non-perishable products and services.

One aspect is a method that enables a buyer to place one or more possibly dissimilar offers for one or more products that may result in the purchase of a predetermined number of the one or more products. The predetermined number may be configured by the buyer. The buyer can place each offer based on a value assigned by the buyer to each product. Sellers of the products are given the opportunity to accept, or take other action on, the offer and as many as the predetermined number of the acceptances may be processed as transactions.

The value assigned by the buyer to each product may be determined, for example, by the value a buyer assigns to various attributes of each product. For example, different values may be assigned to products that belong to the same category but differ in various attributes.

In a specific example, a buyer may assign dissimilar values to two competing products. For example, the first product may be a room in a particular four star hotel in a first location, while the second product may be a room in a four star hotel in a second location. The buyer may prefer the first location and, therefore, may wish to assign a higher value to the first product.

Sellers are incentivized to complete transactions since they are aware that the buyer may have placed other offers with other sellers. Since only a predetermined number of transactions may be processed, each seller is aware that there is a limited time to accept, or take other action on, the offer.

Sellers also receive an optimal price for products being offered. The seller is not necessarily tied to a preconfigured selling price for products, as the seller can react to market conditions and accept prices it deems acceptable at any given time.

In another aspect, a method of negotiating transactions is provided. An offer-acceptance-rejection-counter offer process enables buyers and sellers to exchange counter offers to come to agreement, or the buyer or any seller can unilaterally end the negotiation process.

Buyers can reduce the number of negotiations it is involved in, based on the buyer's perception of which sellers are more likely to complete a transaction. Sellers can leverage negotiations with a first buyer against negotiations with a second buyer.

The present invention can be implemented by a travel seller, a third party aggregator or an auction (or reverse auction) site. For example, a particular travel seller or auction site could implement the present invention to sell only the products of that travel seller, or a third party aggregator or auction (or reverse auction) site could implement the present invention to sell products of a plurality of travel sellers. It should be appreciated that while the following describes decisions made by the seller, in various implementations, an administrator of the third party aggregator or auction (or reverse auction) site could make decisions on behalf of, or in place of, any or all of the sellers.

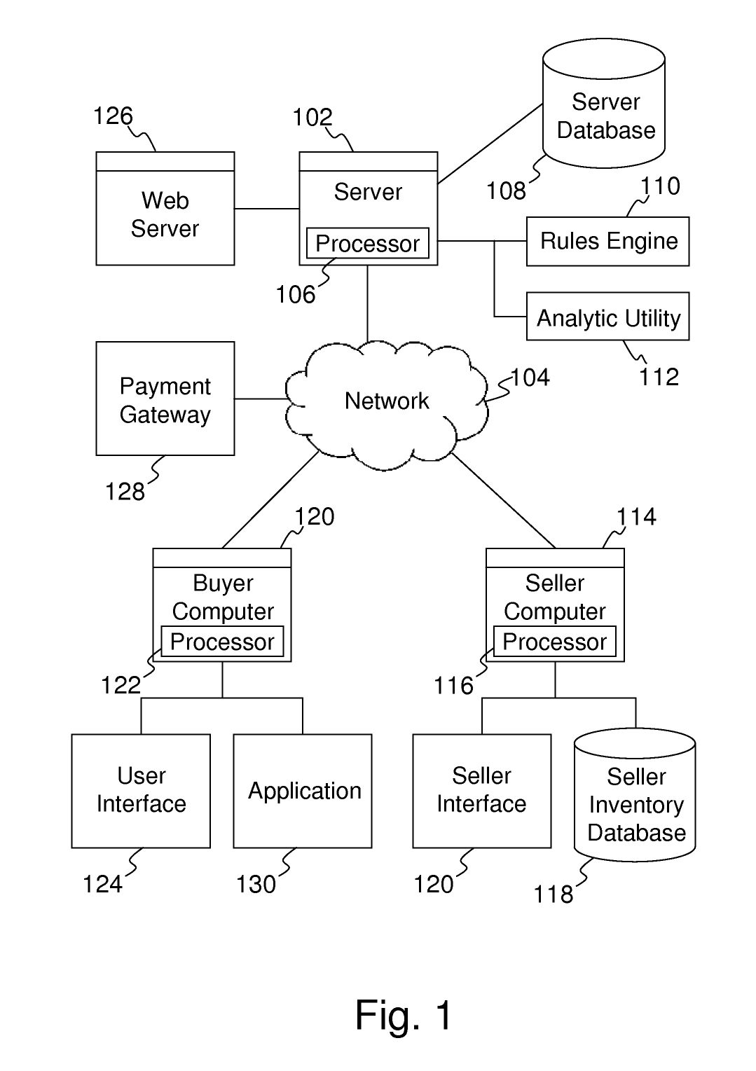

Referring now to FIG. 1, a system in accordance with the present invention includes a server 102 accessible via a network 104, such as the Internet. The server includes, or is linked to, a processor 106 for processing transactions. The server may be linked to a server database 108 for storing or recording the data and information described herein.

The server further includes, or is linked to, a rules engine 110. The rules engine 110 implements a decision tree to enable negotiation and processing of transactions between a buyer and one or more sellers.

The server may also include, or be linked to, an analytics utility 112. The analytics utility 112 may analyze data to provide sellers with analytics and reports corresponding to various metrics including, for example, types of offers received, average offers, mean average and weighted averages of accepted offers, mean average and weighted average of rejected offers, and similar data and reports relating to competitors and to local market trends.

One or more seller computer 114, having a processor 116, is linked to the network 104 to enable communication between the server 102 and the one or more seller computer 114. The seller computer 114 may be linked to a seller inventory database 118 that is configured by a seller to include information regarding the seller's products.

It is understood that, in various embodiments, the seller inventory database 118 can be made accessible to the server 102, the information recorded on the seller inventory database 118 can be replicated on the server database 108, or the seller computer 114 can be configured to provide information regarding the seller's products directly to the server database 108 via the server 102. For simplicity, the following embodiments shall describe an implementation including the seller inventory database 118 being accessible by the server 102.

The seller inventory database 118 may be configured by the seller to include a listing of available inventory of the seller's products for specific times and dates. For each product, the seller may include list pricing, amount of inventory to make available, product attributes, descriptions, pictures or other media, virtual tours, online brochures, etc.

For each product, the seller may also provide a minimum reserve amount (hereinafter, “reserve”) and a “no deal amount”.

The seller can optionally identify in the seller inventory database 118 that the reserve and/or the no deal amount for any of the products is to be dynamically adjusted by the server 102 in response to one or more factors. The factors may include, for example, the time that the product is being requested by the buyer, the amount of time between the potential transaction and the time that the product is required by the buyer, the amount of inventory of the product that has been sold in a given timeframe, the duration that the inventory is requested by the buyer, the prospective usage of the inventory (e.g., number of persons to stay in a hotel room, or distance that a rental car is to be driven), amount of inventory of product for which offers are being submitted, specific day(s) of the week for which offers are made, cancellation restrictions (e.g., no cancellation, cancellation within 24, 48, 72 hours, penalty amounts, etc.) and amount of loyalty or reward points associated with an accepted offer based on the above criteria.

The seller inventory database 118 may also be configured by the seller to include information relating to the seller and/or to all products from the seller. For example, the seller may include seller information, descriptions, pictures or other media, virtual tours, online brochures, etc.

The seller can optionally identify in the seller inventory database 118 that the amount of inventory to be made available is to be dynamically configured by the server 102. For example, the seller may wish to enable the server 102 to dynamically configure the amount of available inventory for a particular product based on information provided by the analytics utility 112. For example, the analytics utility 112 may provide analytics indicating that a particular product will sell well during a specific time. Therefore, the seller may wish to configure the seller inventory database 118 to be dynamically configurable based on data provided by the analytics utility 112. The reserve and/or the no deal amount may also be dynamically configurable in this way.

A seller interface 120 may also be linked to the seller computer 114. The seller interface 120 enables the seller to provide information to the seller inventory database 118. The seller interface 120 also enables the seller to accept, reject or counter offer each offer made by a buyer. The seller interface 120 also enables the server 102 to provide notifications to the seller.

The seller interface 120 may also enable each seller to access marketing tools, purchase and place advertising to be displayed to buyers, and access analytics and reports.

The system further comprises one or more buyer computers 120, each having a processor 122, linked to the network 104 to enable communication between the server 102 and the one or more buyer computers 120. Each buyer computer 120 includes a user interface 124 that enables a buyer to locate, and negotiate to purchase, products configured by the one or more seller.

The user interface 124 enables the buyer to locate products using browse, search or other locating mechanisms. Browsing may be made available by categorizing products based on any of their attributes, the names of the sellers, words appearing in descriptions, by selection of pictures or other media, or any other information associated with particular sellers and products.

Searching may be made available by enabling the buyer to locate products matching, or being within a particular tolerance, of one or more attributes, the names of the sellers, words appearing in descriptions, by selection of pictures or other media, or any other information associated with particular sellers and products.

For example, if the product relates to travel products, such as hotel rooms, the buyer may locate products based on attributes including city, check-in date, check-out date, star rating, brand name, loyalty program, etc.

The analytics utility 110 may also locate products that are likely to be of interest to the buyer, based, for example, on past purchasing behaviour of the buyer or other buyers.

The user interface 124 may enable the buyer to select one or more located products for creating a short list of products. The buyer may then assign a value to each product on the short list. Alternatively, or in addition, the buyer may assign values to products shown without creating a short list.

The user interface 124 also enables the buyer to configure an order of preference to one or more of the located products for which the buyer will be submitting an offer. The order of preference may, in part, determine which offer may be processed as a transaction.

The user interface 124 also enables the buyer to provide a predetermined number of transactions to enter. The predetermined number of transactions is an upper limit to the amount of inventory that the buyer desires to purchase in aggregate from the one or more sellers.

The user interface 124 enables the buyer to submit offers to sellers and to accept, reject or counter offer each offer submitted by a seller. The user interface 124 also enables the server 102 to provide notifications to the buyer. Advertisements may also be displayed to buyers via the user interface 124.

The user interface 124 may also enable the buyer to obtain additional information relating to particular products or to the seller, as provided in any of the seller inventory databases 118. This information includes, for example, brochures, product presentations, virtual tours, reviews/ratings by other buyers, etc. The user interface 124 may also enable the buyer to place reviews/ratings for previously purchased products.

The user interface 124 may be a web interface provided by a web server 126 linked to the server 102. The user interface may, alternatively, be provided by an application 130 executable by the processor 122 on the buyer computer 120.

A payment gateway 128, accessible by the server 102 via the network 104, provided by an administrator of the server 102 or a trusted third party payment clearance entity, may be provided for enabling payment to be made from a buyer to a seller. Any known means of associating payment information with a buyer may be provided. For example, each buyer may provide billing information, such as for a deposit account or credit card, either when registering with the server 102 as a registered user or at the time of making offers. The server 102 is operable to communicate the payment information with the payment gateway 128.

Alternatively, a buyer's billing information could be retained by the server 102 and passed to the seller upon completing a transaction. The seller would then process payment.

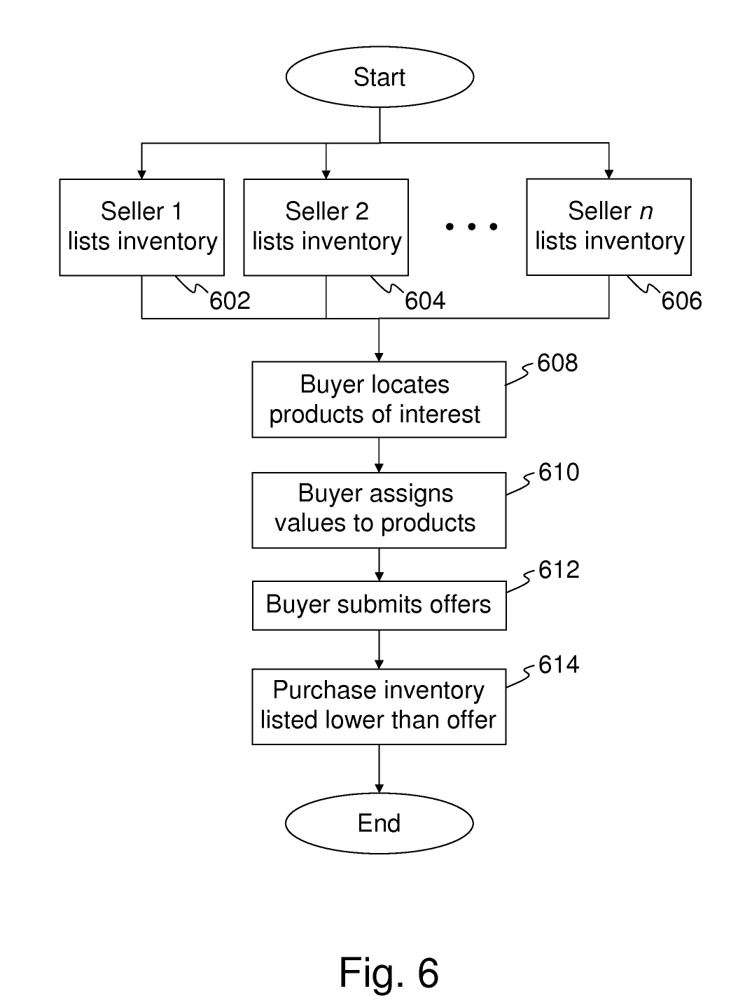

Referring now to FIG. 6, one or more sellers (i.e., sellers {1, 2, . . . , n}) may list inventory of one or more products 602, 604, 606. The listing of inventory for each product includes at least a price. A buyer may locate one or more products of interest 608 from among the listed products.

The buyer may assign possibly dissimilar values to each of the located products 610 for which the buyer wishes to make an offer. The buyer may wish to purchase one of the products (thus the predetermined number of transactions may be assigned to “1”). The buyer may submit the offers 612.

The system enables a purchase to be made of one of the products for which the assigned value by the buyer exceeds the minimum price by the seller 614.

It should be understood that any predetermined number of transactions may be provided.

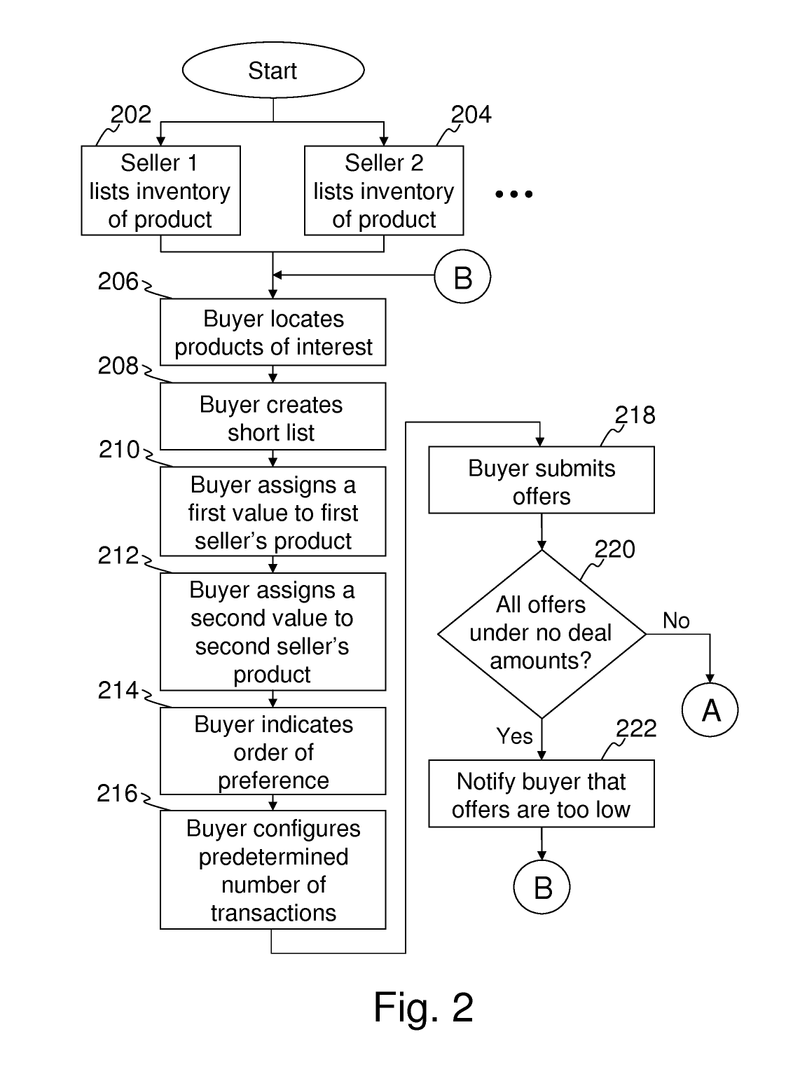

Referring now to FIG. 2, a buyer may be attempting to purchase a product of a particular category from one or more sellers that have listed inventory on one or more seller inventory databases 118. The one or more sellers may list inventory 202, 204 of the product of the particular category. Any number of one or more sellers can list inventory, although two sellers are shown in FIG. 2.

The sellers' products may vary in one or more attributes, such as quality, features, location or reputation, for example.

Sellers may configure a minimum price, or “reserve”, and a no deal amount for each of its products. If a reserve or no deal amount is not configured, the reserve or no deal amount, respectively, may be preconfigured to be zero or any other preconfigured number.

The buyer locates products 206 that may be of interest based upon browsing or searching criteria set by the buyer. The buyer optionally creates a short list 208 of products.

For each located product, or for each product on the short list, the buyer may assign a possibly dissimilar value and submit corresponding offers.

For example, the buyer may create a short list of two products from two sellers. Thus, the buyer may wish to assign a first value to the first seller's product 210 and a second, possibly dissimilar, value to the second seller's product 212. The buyer may also configure an order of preference among the products on which the buyer will be making offers 214.

The buyer can optionally configure the system to process a predetermined number of transactions 216. For example, if the buyer wants only one of the product, the buyer can configure the predetermined number of transactions to be ‘1’. As will be discussed, the system is operable to process one or more transactions up to the predetermined number of transactions.

Once the buyer has prepared one or more offers for products from one or more sellers, the buyer can submit the offers 218 for acceptance by each of the sellers. Each offer corresponds to the possibly dissimilar values assigned 210, 212 to each of the products. It should be appreciated that the buyer need not submit an offer for all products or to all sellers.

The rules engine 110 determines whether all of the buyer's offers are less than their respective no deal amounts 220. If all of the buyer's offers are below each seller's no deal amount, the buyer may be notified that its offers are too low 222. The buyer may be given the option to provide a new set of one or more offers at step 206.

If one or more of the buyer's offers meets or exceeds the no-deal amount, those offers that meet or exceed the reserve may be processed 224 by the rules engine 110 to determine which offers to provide to sellers for acceptance.

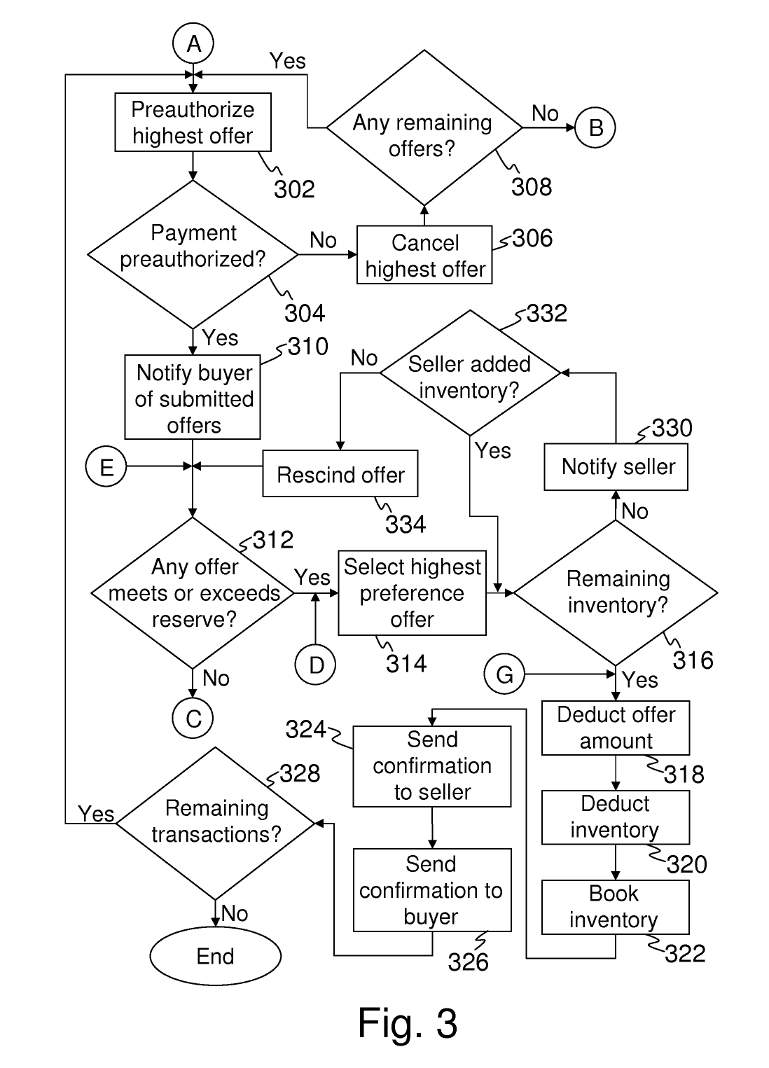

Referring now to FIG. 3, as long as one or more offer meets or exceeds its respective no deal amount, the server 102 may submit the amount of the buyer's highest offer (including, optionally, applicable taxes, service fees and other charges) to the payment gateway 128 to preauthorize payment 302. For example, the buyer's payment account may be preauthorized for the amount of the highest offer to ensure the buyer can pay for the one or more products to be purchased.

The server 102 determines whether the payment gateway 128 has preauthorized the payment 304.

If the buyer's payment account is not successfully preauthorized, the rules engine 110 may cancel the buyer's highest offer 306, and determine whether there are any remaining offers 308.

If there are remaining offers, the server 102 may attempt to preauthorize the next highest offer 302 with the payment gateway 128. If all the buyer's offers are cancelled, the buyer can locate another set of products of interest 206. All offers that remain after the remaining highest offer is preauthorized may be further processed by the rules engine 110.

If the buyer's payment account is successfully preauthorized, the buyer may be notified 310 that its offers have been submitted.

The rules engine 110 then determines whether each of the buyer's remaining offers meets or exceeds the reserve for its respective product 312.

If one or more of the buyer's offers meets or exceeds the reserve for its respective product, an acceptance signal is generated and these offers may be processed by the rules engine 110 in the order of preference previously configured by the buyer. If the buyer did not configure an order of preference, then the processing order may be determined by highest offer, lowest offer, random offer, sponsored offer, or another predetermined order.

The offer with the highest order of preference is selected for processing 314. Once an offer is selected for processing, the seller inventory database 118 corresponding to the offer is queried to determine whether there is remaining inventory for the particular product 316.

If there is remaining inventory, the server 102 directs the payment gateway 128 to deduct the offer amount (including, optionally, applicable taxes, service fees and other charges) from the buyer's payment account 318, deducts inventory of the product from the respective seller inventory database 320, and books the inventory for the buyer 322. A confirmation message can be sent to the seller 324 and/or buyer 326 to confirm the transaction.

The rules engine 110 determines whether the number of transactions processed is less than the buyer's predetermined number of transactions 328. If so, further transactions can be processed from step 302. Optionally, the same seller involved in a completed transaction can be involved in a further transactions. For example, a buyer could purchase two or more of a product from a particular seller.

If there is no remaining inventory from the seller, the seller may be notified that it has the option to add inventory to accept the offer 330. The server 102 determines whether the seller has added inventory 332. If so, the transaction may be processed by the rules engine 110 from step 316. Otherwise, the offer to that particular seller may be rescinded 334, and the transaction may be processed by the rules engine 110 from step 310.

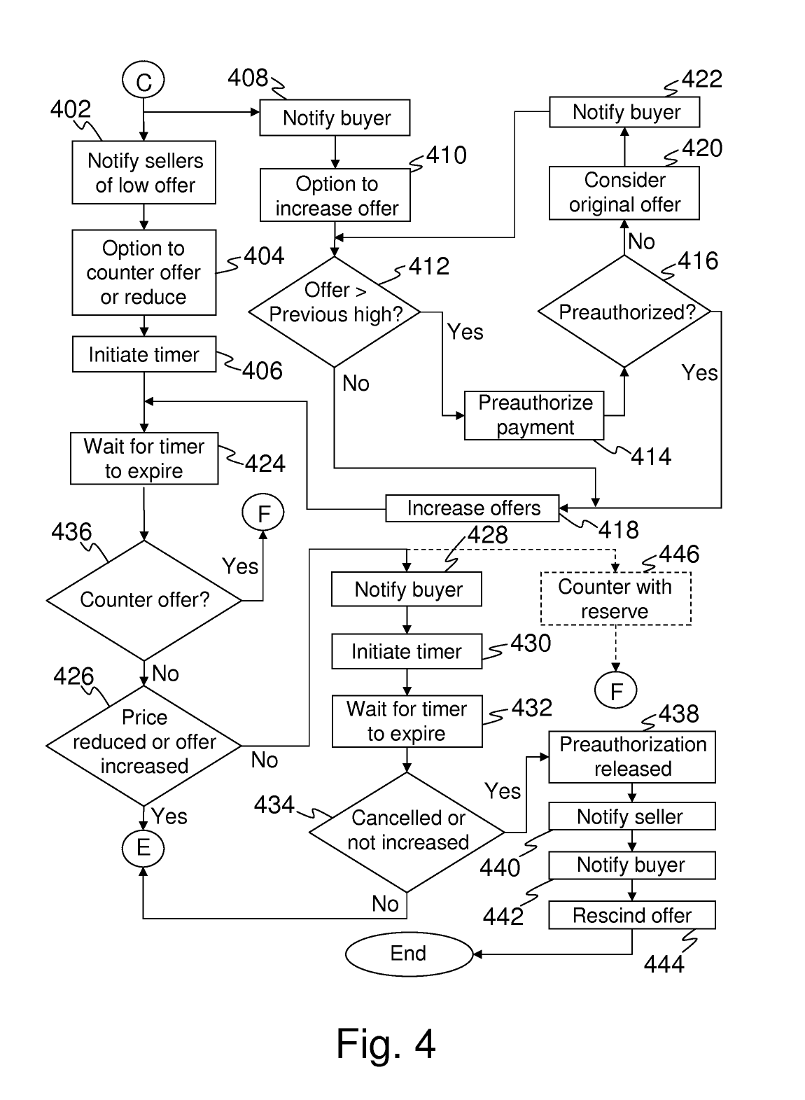

Referring now to FIG. 4, if all offers are less than the reserve for their respective products, a rejection signal is generated and the sellers corresponding to the offers may be notified 402 that a buyer has submitted an offer lower than its respective reserve. Each seller may be given the option to reduce the reserve for the respective offer, or to counter offer to the buyer 404. The rules engine 110 may provide sellers with a preconfigured amount of time 406 to reduce their reserve or counter offer.

Concurrently, a notification may be provided to the buyer 408, providing the buyer with the option to increase its offer 410 within the same preconfigured amount of time 406 that the seller has been provided. If the buyer increases any of its offers above its previous high offer 412, the new high offer may require a payment preauthorization 414 by the payment gateway 128. If the increased offer is preauthorized 416, the rules engine 110 may deem all increased offers up to the preauthorized amount to become the offers for the respective products 418. If the increased offer is not preauthorized for payment 416, the buyer's original offer may still be considered 420, and the buyer may be so notified 422. The next highest increased offer can be preauthorized, if any are made, until a preauthorization amount is determined or until no increased offers exceed the previously preauthorized amount.

Once the preconfigured amount of time expires 424, the rules engine 110 determines whether the seller counter offered 436. If not, the rules engine 110 determines whether either the buyer increased its offer or one or more of the sellers reduced their reserve to an amount less than the buyer's offer for the particular product 426. If so, the rules engine 110 may process the transaction from step 312.

If none of the sellers reduced their reserve to an amount less than the buyer's offer for the particular product, nor counter offered to the buyer, a notification 428 can be provided to the buyer to increase one or more of its offers. Alternatively, the rules engine 110 may automatically counter offer to the buyer with the minimum reserve price 446.

The rules engine 110 may provide the buyer with a preconfigured amount of time 430 to increase one or more of its offers.

Once the preconfigured amount of time expires 432, the rules engine 110 determines whether the buyer cancelled all of its offers, or did not increase any of its offers 434. If so, the preauthorization may be released 438, a notification sent to the sellers 440 and/or buyer 442 to notify the sellers and buyer that the offer is rescinded, and rescinding the offer 444. The transaction is then terminated.

If it is determined that the buyer increased one or more of its offers 434 within the preconfigured amount of time, the transaction may be processed by the rules engine 110 from step 312.

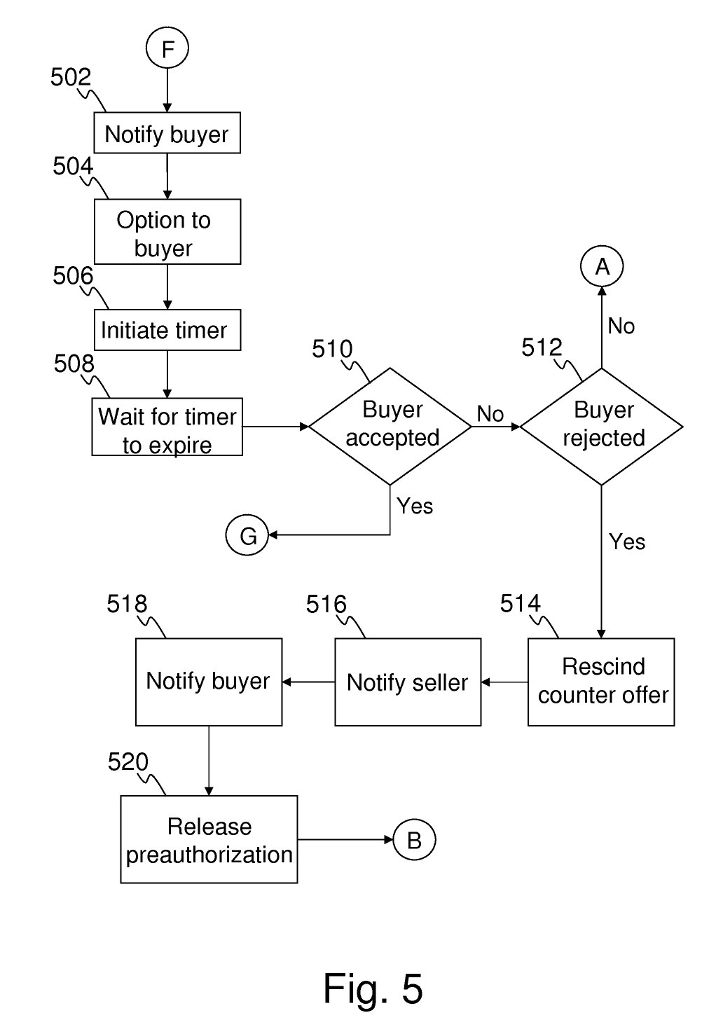

Referring now to FIG. 5, if a seller counter offers to a buyer, a notification may be provided to the buyer 502, notifying the buyer of the counter offer and providing the buyer with the option to accept or reject the counter offer, or provide a further counter offer 504. The buyer may be provided with a preconfigured amount of time to accept or reject the counter offer, or provide a further counter offer 506.

Once the preconfigured amount of time expires 508, the rules engine 110 determines whether the buyer accepted the counter offer 510, in which case the transaction may be processed by the rules engine 110 from step 318.

If not, the rules engine 110 determines whether the buyer rejected the counter offer or failed to respond within the preconfigured time 512, the counter offer is rescinded 514 and the transaction is terminated 514. A notification that the transaction has been terminated may be provided to the seller 516 and/or buyer 518. The preauthorization may also be released 520. The buyer may locate another set of products of interest 206.

If the buyer provides a further counter offer, the transaction may be processed by the rules engine 110 from step 302.

The rules engine 110 may repeatedly process additional transactions beginning at step 302 until as many as the predetermined number of transactions have been processed. It is possible that fewer than the predetermined number of transactions will be processed, since the buyer may not be offering a high enough price to obtain the products to satisfy the predetermined number of transactions, or the buyer may not be able to have payment preauthorized to satisfy the predetermined number of transactions.

If the one or more sellers accept one or more offers, but fewer than the predetermined number of transactions, then the accepted transactions can be processed, and the one or more sellers may be given the option of providing counter offers to the buyer.

Once each transaction is completed, the server 102 may optionally provide to the seller the ability to communicate upgrade options to the buyer. Upgrade options could be communicated to the buyer through notifications, for example.

Although the above has been described with reference to certain specific embodiments, various modifications thereof will be apparent to those skilled in the art as outlined in the appended claims.

We claim:

1. A computer implemented method for processing one or more transactions, the method characterized by:
(a) enabling one or more sellers to provide one or more products, each said product being made available for a respective price;
(b) defining a predetermined number of transactions;
(c) enabling a buyer to submit one or more possibly dissimilar offers for one or more of said products; and
(d) processing, by a computer processor, one or more transactions, each said transaction including a purchase of one of said products if said offer is greater than or equal to said price, wherein the number of said transactions processed is less than or equal to said predetermined number of transactions.

2. The computer implemented method of claim 1, characterized by the further step of enabling one or more of said sellers to submit a respective counter offer to said buyer if said number of said transactions processed is less than said predetermined number of transactions.

3. The computer implemented method of claim 2, characterized by the further step of enabling said buyer to accept said counter offer, reject said counter offer, or submit a further counter offer to a respective one of said sellers if said number of said transactions processed is less than said predetermined number of transactions.

4. The computer implemented method of claim 1, characterized by enabling said buyer to configure an order of preference, said order of preference determining an order in which to process said transactions.

5. The computer implemented method of claim 1, characterized by enabling said buyer to define said predetermined number of transactions.

6. The computer implemented method of claim 1, characterized in that said predetermined number of transactions is one.

7. The computer implemented method of claim 1, characterized by the further step of enabling one or more of said sellers to lower said price of a respective one of said products if said number of said transactions processed is less than said predetermined number of transactions.

8. The computer implemented method of claim 1, characterized by the further step of enabling said buyer to raise said offer for a respective one of said products if said number of said transactions processed is less than said predetermined number of transactions.

9. The computer implemented method of claim 1, characterized by the further step of enabling said buyer to create a short list comprising one or more of said products.

10. The computer implemented method of claim 1, characterized by the further step of enabling one or more of said sellers to increase the amount of a respective one or more of said product being made available if said number of said transactions processed is less than said predetermined number of transactions.

11. A system for processing one or more transactions, the system characterized by:
(a) a seller inventory database, said seller inventory database enabling one or more sellers to provide one or more products, each said product being made available for a price;
(b) a buyer computer, said buyer computer enabling a buyer to submit one or more possibly dissimilar offers for one or more of said products; and
(c) a network accessible server in network communication with said seller inventory database and said buyer computer, said server operable to process one or more transactions, wherein each said transaction includes a purchase of one of said products if said offer is greater than or equal to said price, wherein the number of said transactions processed is less than or equal to said predetermined number of transactions.

12. The system of claim 11, characterized in that said server enables one or more of said sellers to submit a respective counter offer to said buyer if said number of said transactions processed is less than said predetermined number of transactions.

13. The system of claim 12, characterized in that said buyer computer enables said buyer to accept said counter offer, reject said counter offer, or submit a further counter offer to a respective one of said sellers if said number of said transactions processed is less than said predetermined number of transactions.

14. The system of claim 11, characterized in that said buyer computer enables said buyer to configure an order of preference, said order of preference determining an order in which to process said transactions.

15. The system of claim 11, characterized in that said buyer computer enables said buyer to define said predetermined number of transactions.

16. The system of claim 11, characterized in that said predetermined number of transactions is one.

17. The system of claim 11, characterized in that said server enables one or more of said sellers to lower said price of a respective one of said products if said number of said transactions processed is less than said predetermined number of transactions.

18. The system of claim 11, characterized in that said buyer computer enables said buyer to raise said offer for a respective one of said products if said number of said transactions processed is less than said predetermined number of transactions.

19. The system of claim 11, characterized in that said buyer computer enables said buyer to create a short list comprising one or more of said products.

20. The system of claim 11, characterized in that said server enables one or more of said sellers to increase the amount of a respective one or more of said product being made available if said number of said transactions processed is less than said predetermined number of transactions.

21. A computer implemented method for negotiating a transaction, the method characterized by:
(a) enabling one or more sellers to provide one or more products, each said product being made available for a price;
(b) enabling a buyer to submit one or more possibly dissimilar offers for one or more of said products;
(c) generating, by a computer processor, a rejection signal if each said offer is less than a respective one of said price, said rejection signal enabling at least one of said one or more sellers to revise said price of a respective one of said products for providing a counter offer to said buyer; and
(d) generating, by a computer processor, an acceptance signal if at least one offer is greater than or equal to a respective one of said price, said acceptance signal enabling processing, by a computer processor, of said transaction, said transaction including a purchase of at least one of said products for which a respective one of said offer is greater than or equal to a respective one of said price.

22. The computer implemented method of claim 21, characterized by enabling said buyer to accept said counter offer, reject said counter offer, or submit a further counter offer to one or more of said sellers if said or more of said sellers revise said price of a respective one of said products.

23. The computer implemented method of claim 21, characterized in that said rejection signal further enables said buyer to raise said offer for one or more of said products.

24. The computer implemented method of claim 23, characterized by enabling one or more of said sellers to accept said raised offer, reject said raised offer or submit a further counter offer to said buyer if said buyer raises said offer.

25. A system for negotiating a transaction, the system characterized by:
(a) a seller inventory database, said seller inventory database enabling one or more sellers to provide one or more products, each said product being made available for a price;
(b) a buyer computer, said buyer computer enabling a buyer to submit one or more possibly dissimilar offers for one or more of said products; and
(c) a network accessible server in network communication with said seller inventory database and said buyer computer, said server operable to generate a rejection signal if each said offer is less than a respective one of said price, said rejection signal enabling at least one of said one or more sellers to revise said price for providing a counter offer to said buyer, and generate an acceptance signal if at least one offer is greater than or equal to a respective one of said price, said acceptance signal enabling processing, by a computer processor, of said transaction, said transaction including a purchase of at least one of said products for which a respective one of said offer is greater than or equal to a respective one of said price.

26. The system of claim 25, characterized by enabling said buyer to accept said counter offer, reject said counter offer, or submit a further counter offer to one or more of said sellers if said or more of said sellers revise said price of a respective one of said products.

27. The system of claim 25, characterized in that said rejection signal further enables said buyer to raise said offer for one or more of said products.

28. The system of claim 27, characterized by enabling one or more of said sellers to accept said raised offer, reject said raised offer or submit a further counter offer to said buyer if said buyer raises said offer.
